(19) United States
(12) Patent Application Publication
(10) Pub. No.: US 2012/0273153 A1
(43) Pub. Date: Nov. 1, 2012

(54) Casting mold having a stabilized inner casting core, casting method and casting part

(76) Inventors: Fathi Ahmad, Kaarst (DE); Winfried Esser, Bochum (DE); Uwe Paul, Ratingen (DE)

(21) Appl. No.: 13/513,308

(22) PCT Filed: May 31, 2010
(86) PCT No.: PCT/EP10/57530

§ 371 Date: Jul. 18, 2012

(30) Foreign Application Priority Data
Dec. 3, 2009 (EP) EP09015013

(51) Int. Cl. B28B 7/40; C22C 19/07; B22D 25/06; C22C 19/05

(52) U.S. Cl. 164/47; 420/448; 420/436; 420/438; 420/439; 249/114.1

(57) ABSTRACT

A casting mold for a metal melt is provided. By coating a core of a casting mold, the core may be mechanically stabilized and an inner coating of the component to be cast may be obtained, wherein the coating preferably serves as an anti-corrosion layer. A method for producing a cast part using the casting mold is also provided.

### CROSS REFERENCE TO RELATED APPLICATIONS

This application is the US National Stage of International Application No. PCT/EP2010/057530, filed May 31, 2010 and claims the benefit thereof. The International Application claims the benefits of European Patent Office application No. 09015013.7 EP filed Dec. 3, 2009. All of the applications are incorporated by reference herein in their entirety.

### FIELD OF INVENTION

The invention relates to a casting mold having a stabilizing layer on the inner core of a casting mold, to a casting process and to a cast part.

### BACKGROUND OF INVENTION

For casting, cores are often inserted into an, in particular ceramic, mold which is already present in order to cast hollow components, or, as in the investment casting process, cores are placed into a wax mold and a wax model is produced with the ceramic core, which is used in turn to produce a ceramic mold in which the ceramic core is then integrated. It is often the case that the thin core does not have sufficient mechanical stability, which can lead to fracture of the core during the production of the casting mold or during the actual casting process.

### SUMMARY OF INVENTION

Therefore, it is an object of the invention to solve this problem.

The object is achieved by a casting mold having a stabilized inner core as claimed in the claims, by a process as claimed in the claims and by a cast part as claimed in the claims.

The claims list further advantageous measures which can be combined with one another, as desired, in order to obtain further advantages.

### BRIEF DESCRIPTION OF THE DRAWINGS

FIGS. 1, 2 show a schematic illustration of the invention,

FIG. 3 shows a turbine blade or vane,

FIG. 4 shows a combustion chamber, and

FIG. 5 shows a list of superalloys.

The invention and the description represent merely exemplary embodiments of the invention.

### DETAILED DESCRIPTION OF INVENTION

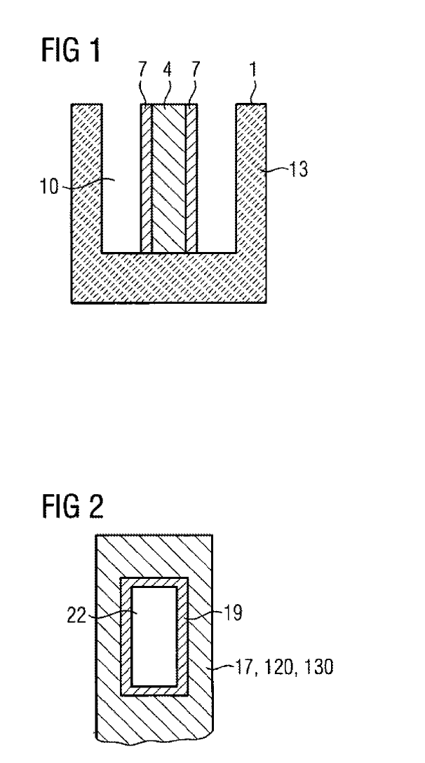

FIG. 1 shows a, preferably ceramic, casting mold 1 with an outer wall 13 and an inner core 4. The core 4 can be formed separately or can be an integral component part of the casting mold 1.

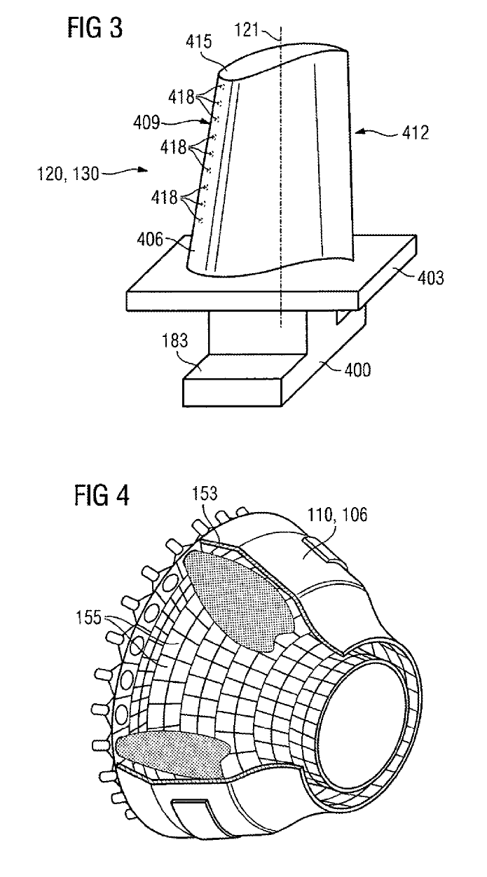

The casting mold 1 is used with preference for a turbine blade or vane 120, 130 (FIG. 3), i.e. a hollow component of a gas turbine 100 (FIG. 2).

An inner, in particular ceramic, core 4 is inserted into, or is present in, the casting mold 1 with the outer wall 13, said core 4 having a mechanically stabilizing metallic layer 7.

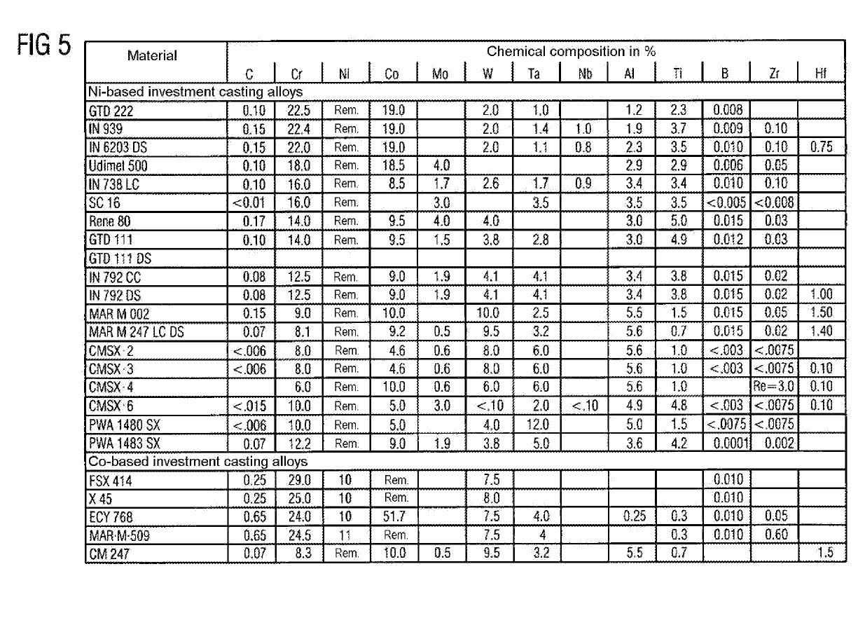

A melt of a metal of the cast part to be produced is then introduced into the hollow space 10 between the outer wall 13 and the core 4. The metal is preferably an alloy as per FIG. 5.

The metallic layer 7 on the core 4 mechanically stabilizes the core 4, since the metal in the layer 7 has strength and ductility.

In addition, the composition of the layer 7 is selected such that the layer 7 melts upon introduction of the melt and, upon solidification of the melt 16, is diffused into the later cast part for the most part, in particular completely.

The difference between the melting point of the melt and that of the material of the layer 7 is preferably at least 10° C., very particularly at least 20° C.

The layer 7 can thus be an aluminum coating or an aluminum alloy.

Similarly advantageous is an MCrAl(X) coating, preferably with rhenium, where M stands for nickel (Ni) and/or cobalt (Co) and X=yttrium.

The chromium content is then preferably more than 15% by weight.

The aluminum content is preferably between 7% by weight and 18% by weight.

The nickel content is preferably more than 25% and the cobalt content is preferably more than 10%.

In addition, elements such as yttrium (0.2% to 1%), carbon (50 ppm-250 ppm), boron (0.007%-0.012%), zirconium (0.015%-0.012%) or hafnium (0.1%-1.5%) may preferably be present for lowering the melting point of the metallic layer 7, preferably of the MCrAl(X) layer.

The addition of yttrium (Y) is preferable.

Carbon (C), boron (B), zirconium (Zr) and hafnium (Hf) serve for lowering the melting point.

Constituents of a superalloy, such as titanium (Ti) (0.5%-4.0%), molybdenum (Mo) (0.5%-3.0%), tantalum (Ta) (0.5%-2.0%) or niobium (Nb) (0.5%-2.0%), can similarly contribute to the strength and/or to the lowering of the melting point in the layer 7.

The metallic layer 7 can be applied to the casting core 4 preferably by dipping processes, by brushing, spraying processes (cold, hot).

The region 19 of the cast part 17, 120, 130 represents the diffused-in region of the material of the layer 7 in the hollow space 22 of the cast part (FIG. 2).

In addition, as a result of the diffusion of the layer 7, the cast part 17, 120, 130 is provided with internal oxidation protection.

FIG. 3 shows a perspective view of a rotor blade 120 or guide vane 130 of a turbomachine, which extends along a longitudinal axis 121.

The turbomachine may be a gas turbine of an aircraft or of a power plant for generating electricity, a steam turbine or a compressor.

The blade or vane 120, 130 has, in succession along the longitudinal axis 121, a securing region 400, an adjoining blade or vane platform 403 and a main blade or vane part 406 and a blade or vane tip 415.

As a guide vane 130, the vane 130 may have a further platform (not shown) at its vane tip 415.

A blade or vane root 183, which is used to secure the rotor blades 120, 130 to a shaft or a disk (not shown), is formed in the securing region 400.

The blade or vane root 183 is designed, for example, in hammerhead form. Other configurations, such as a fir-tree or dovetail root, are possible.

The blade or vane 120, 130 has a leading edge 409 and a trailing edge 412 for a medium which flows past the main blade or vane part 406.

In the case of conventional blades or vanes 120, 130, by way of example solid metallic materials, in particular superalloys, are used in all regions 400, 403, 406 of the blade or vane 120, 130.

Superalloys of this type are known, for example, from EP 1 204 776 B1, EP 1 306 454, EP 1 319 729 A1, WO 99/67435 or WO 00/44949.

The blade or vane 120, 130 may in this case be produced by a casting process, by means of directional solidification, by a forging process, by a milling process or combinations thereof.

Workpieces with a single-crystal structure or structures are used as components for machines which, in operation, are exposed to high mechanical, thermal and/or chemical stresses.

Single-crystal workpieces of this type are produced, for example, by directional solidification from the melt. This involves casting processes in which the liquid metallic alloy solidifies to form the single-crystal structure, i.e. the single-crystal workpiece, or solidifies directionally.

In this case, dendritic crystals are oriented along the direction of heat flow and form either a columnar crystalline grain structure (i.e. grains which run over the entire length of the workpiece and are referred to here, in accordance with the language customarily used, as directionally solidified) or a single-crystal structure, i.e. the entire workpiece consists of one single crystal. In these processes, a transition to globular (polycrystalline) solidification needs to be avoided, since non-directional growth inevitably fauns transverse and longitudinal grain boundaries, which negate the favorable properties of the directionally solidified or single-crystal component.

Where the text refers in general terms to directionally solidified microstructures, this is to be understood as meaning both single crystals, which do not have any grain boundaries or at most have small-angle grain boundaries, and columnar crystal structures, which do have grain boundaries running in the longitudinal direction but do not have any transverse grain boundaries. This second form of crystalline structures is also described as directionally solidified microstructures (directionally solidified structures).

Processes of this type are known from U.S. Pat. No. 6,024,792 and EP 0 892 090 A1.

The blades or vanes 120, 130 may likewise have coatings protecting against corrosion or oxidation e.g. (MCrAlX; M is at least one element selected from the group consisting of iron (Fe), cobalt (Co), nickel (Ni), X is an active element and stands for yttrium (Y) and/or silicon and/or at least one rare earth element, or hafnium (Hf)). Alloys of this type are known from EP 0 486 489 B1, EP 0 786 017 B1, EP 0 412 397 B1 or EP 1 306 454 A1.

The density is preferably 95% of the theoretical density.

A protective aluminum oxide layer (TGO=thermally grown oxide layer) is formed on the MCrAlX layer (as an intermediate layer or as the outermost layer).

The layer preferably has a composition Co-30Ni-28Cr-8Al-0.6Y-0.7Si or Co-28Ni-24Cr-10Al-0.6Y. In addition to these cobalt-based protective coatings, it is also preferable to use nickel-based protective layers, such as Ni-10Cr-12Al-0.6Y-3Re or Ni-12Co-21Cr-11Al-0.4Y-2Re or Ni-25Co-17Cr-10Al-0.4Y-1.5Re.

It is also possible for a thermal barrier coating, which is preferably the outermost layer, to be present on the MCrAlX, consisting for example of ZrO₂, Y₂O₃-ZrO₂, i.e. unstabilized, partially stabilized or fully stabilized by yttrium oxide and/or calcium oxide and/or magnesium oxide.

The thermal barrier coating covers the entire MCrAlX layer.

Columnar grains are produced in the thermal barrier coating by suitable coating processes, such as for example electron beam physical vapor deposition (EB-PVD).

Other coating processes are possible, e.g. atmospheric plasma spraying (APS), LPPS, VPS or CVD. The thermal barrier coating may include grains that are porous or have micro-cracks or macro-cracks, in order to improve the resistance to thermal shocks. The thermal barrier coating is therefore preferably more porous than the MCrAlX layer.

The blade or vane 120, 130 may be hollow or solid in form. If the blade or vane 120, 130 is to be cooled, it is hollow and may also have film-cooling holes 418 (indicated by dashed lines).

FIG. 4 shows a combustion chamber 110 of the gas turbine 100.

The combustion chamber 110 is configured, for example, as what is known as an annular combustion chamber, in which a multiplicity of burners 107, which generate flames 156, arranged circumferentially around an axis of rotation 102 open out into a common combustion chamber space 154. For this purpose, the combustion chamber 110 overall is of annular configuration positioned around the axis of rotation 102.

To achieve a relatively high efficiency, the combustion chamber 110 is designed for a relatively high temperature of the working medium M of approximately 1000° C. to 1600° C. To allow a relatively long service life even with these operating parameters, which are unfavorable for the materials, the combustion chamber wall 153 is provided, on its side which faces the working medium M, with an inner lining formed from heat shield elements 155.

Moreover, a cooling system may be provided for the heat shield elements 155 and/or their holding elements, on account of the high temperatures in the interior of the combustion chamber 110. The heat shield elements 155 are then, for example, hollow and may also have cooling holes (not shown) opening out into the combustion chamber space 154.

On the working medium side, each heat shield element 155 made from an alloy is equipped with a particularly heat-resistant protective layer (MCrAlX layer and/or ceramic coating) or is made from material that is able to withstand high temperatures (solid ceramic bricks).

These protective layers may be similar to the turbine blades or vanes, i.e. for example MCrAlX: M is at least one element selected from the group consisting of iron (Fe), cobalt (Co), nickel (Ni), X is an active element and stands for yttrium (Y) and/or silicon and/or at least one rare earth element or hafnium (Hf). Alloys of this type are known from EP 0 486 489 B1, EP 0 786 017 B1, EP 0 412 397 B1 or EP 1 306 454 A1.

It is also possible for a, for example ceramic, thermal barrier coating to be present on the MCrAlX, consisting for example of ZrO₂, Y₂O₃-ZrO₂, i.e. unstabilized, partially stabilized or fully stabilized by yttrium oxide and/or calcium oxide and/or magnesium oxide.

Columnar grains are produced in the thermal barrier coating by suitable coating processes, such as for example electron beam physical vapor deposition (EB-PVD).

Other coating processes are possible, e.g. atmospheric plasma spraying (APS), LPPS, VPS or CVD. The thermal barrier coating may include grains that are porous or have micro-cracks or macro-cracks, in order to improve the resistance to thermal shocks.

Refurbishment means that after they have been used, protective layers may have to be removed from turbine blades or vanes 120, 130 or heat shield elements 155 (e.g. by sand-blasting). Then, the corrosion and/or oxidation layers and products are removed. If appropriate, cracks in the turbine blade or vane 120, 130 or in the heat shield element 155 are also repaired. This is followed by recoating of the turbine blades or vanes 120, 130 or heat shield elements 155, after which the turbine blades or vanes 120, 130 or the heat shield elements 155 can be reused.

1-11. (canceled)

12. A casting mold for a metal melt, comprising:
an outer wall; and
a casting core which has a metallic coating for the stabilization thereof,
wherein the composition of the metallic coating is selected such that it is no longer present on the casting core after the melt has been cast, and
wherein the melting point of the metallic coating is not higher than that of the metal to be cast.

13. The casting mold as claimed in claim 12,
wherein the casting mold is ceramic.

14. The casting mold as claimed in claim 13, wherein the casting core is ceramic.

15. The casting mold as claimed in claim 12, wherein the metallic coating is an aluminum-containing layer.

16. The casting mold as claimed in claim 15, wherein the metallic coating is a layer of aluminum.

17. The casting mold as claimed in claim 12, wherein the metallic coating is an MCrAl or MCrAlX coating.

18. The casting mold as claimed in claim 17, wherein the chromium content of the metallic coating or of the MCrAl(X) alloy is more than 15% by weight.

19. The casting mold as claimed in claim 18, wherein the chromium content of the metallic coating or of the MCrAl(X) alloy is more than 20% by weight.

20. The casting mold as claimed in claim 17, wherein the aluminum content of the metallic coating or of the MCrAl(X) alloy is between 7% by weight and 18% by weight.

21. The casting mold as claimed in claim 20, wherein the aluminum content of the metallic coating or of the MCrAl(X) alloy is between 13% by weight and 18% by weight.

22. The casting mold as claimed in claim 12, wherein the metallic coating comprises elements selected from the group consisting of yttrium, carbon, boron, zirconium, hafnium and combinations thereof for lowering the melting point.

23. The casting mold as claimed in claim 12, wherein the metallic coating comprises titanium, molybdenum, tantalum and/or niobium for lowering the melting point.

24. A process for producing a cast part,
pouring a melt into a casting mold and allowing the melt to solidify; and
the metallic coating is substantially diffused from a casting core into the cast part,
wherein the process uses the casting mold as claimed in claim 12.

25. The process as claimed in claim 24,
wherein the metallic coating is substantially diffused from the casting core into the cast part to at least to an extent of 80%.

26. The process as claimed in claim 24,
wherein the metallic coating is diffused completely from the casting core into the cast part.

27. A cast part produced by the process as claimed in claim 24.
